(19) United States
(12) Patent Application Publication
(10) Pub. No.: US 2026/0276188 A1
(43) Pub. Date: Sep. 17, 2026

(54) OUTDOOR LIGHT FIXTURE INCLUDING A VENTING REFRACTOR

(71) Applicant: SIGNIFY HOLDING B.V., EINDHOVEN (NL)

(72) Inventor: EDGAR PEREZ, MONTREAL (CA)

(21) Appl. No.: 19/168,892

(22) PCT Filed: Mar. 20, 2024
(86) PCT No.: PCT/EP2024/057450

§ 371 Date: Sep. 25, 2025

Related U.S. Application Data
(60) Provisional application No. 63/455,025, filed on Mar. 28, 2023.

(30) Foreign Application Priority Data
May 25, 2023 (EP) 23175258.5

(51) Int. Cl. F21V 29/83; F21V 5/00; F21W 131/103

(52) U.S. Cl. CPC F21V 29/83; F21V 5/00; F21W 2131/103

(57) ABSTRACT

A lighting fixture (100) is disclosed that includes a housing (101) and a lighting module (105) that is coupled to the housing (101). A refractor (102) is coupled to the lighting fixture (100 that includes an inner surface (106) and an outer surface (107) that from at least one side wall (118), a top aperture (108) and a bottom aperture (109). The refractor (102) also includes a coupling feature (110) including a portion (120) that is positioned above a top edge (116) of the at least one side wall (118). The refractor 102 is positioned to allow light from the lighting module (105) to pass through the top aperture (108) and the bottom aperture (109). The coupling feature forms a ventilation gap (114) between the refractor (102) and the housing (101).

### FIELD OF THE INVENTION

The invention relates generally to lighting fixtures, and in particular, to an outdoor lighting fixture including a refractor designed to facilitate heat dissipation.

### BACKGROUND

Configurable luminaires are typically used for outdoor environmental lighting, including, for example, streetlamps, parking lighting, pathway lighting, rural settings, farmlands, and general security and so forth. Such conventional outdoor or high mast luminaires include three main sub-assemblies: mast structure, headframe (or housing), and lighting module. The headframe can be configured to include one or more lighting modules to provide different light distribution as required for the particular application. Such outdoor luminaires may be configured to provide different light distribution in accordance with various codes and requirements. Such outdoor luminaires often use a refractor as an accessory to help with light distribution and to customize the lighting pattern which makes it easier to see the light from far away.

One aspect of such conventional outdoor luminaires is that a painted enclosure is not always required. While this lowers the cost of such outdoor luminaries, unpainted luminaires create a problem by increasing the operating temperature of the outdoor luminaire due to heat absorption from the environment and heat generated by the operating current of the luminaire. In addition, conventional refractors may also increase temperature because hot air is trapped by the shape and positioning of the refractor. For example, when coupled to the luminaire, the refractor may form a pocket which traps hot air that cannot be dissipated due to lack of air flow. These factors may cause problems associated with the durability of the outdoor luminaire associated with thermal dissipation and high-temperature problems, which end up affecting the light intensity and service life.

For example, convention Light Emitting Diodes (LEDs) are known to perform worse the higher the ambient outside temperature. 77 degrees, or 25 degrees Celsius, is the near-universal temperature standard against which L70 ratings are calculated by lighting manufacturers. For instance, if an LED is L70 rated at 200,000 hours, that means that after 200,000 hours of continuous use at 77 degrees Fahrenheit, the lumens will have depreciated by 30%.

In this regard, the maximum ambient temperature for operation of an outdoor luminaire is an important design consideration. If operated above the maximum ambient temperature rating, the LEDs of such outdoor luminaires will degrade in light output faster over its operational life.

Conventional outdoor luminaires may include features that try to reduce heat-related lumen depreciation. For example, built-in heat sinks may be used to channel excess electrical heat and keep it away from the electrical components such as drivers and the LED modules. However, such heat sinks may not be sufficient to address the all heat related issues. Open-air LED luminaire are also known in the art which allow heat to be dissipated due air flow around the luminaire. However, when a refractor is used with such conventional open-air LED luminaires, it may cause hot air to be trapped in a pocket formed by an inverted U-shaped or bowl-shaped refractor which causes increased temperature/heat due to the lack of ventilation/airflow.

### SUMMARY OF THE PRESENT INVENTION

Aspects, objects, and embodiments of the present invention address the shortcomings discussed above.

One aspect of the present invention is related to a luminaire that includes refractor for light distribution that also allows for air flow and venting of heat away from the luminaire, so that the temperature increases around LED modules of the luminaire is reduced as compared to conventional refractors.

Another aspect of the present invention is related to an unpainted outdoor luminaire with a refractor and other heat dissipation elements that has a maximum ambient operating temperature of 40 C.

One embodiment of the present invention is directed to a lighting fixture that includes a housing, a lighting module that is coupled to the housing and a refractor coupled to the lighting fixture. The refractor includes an inner surface and an outer surface that form one or more side walls, a top aperture and a bottom aperture. A coupling feature of the refractor includes a portion that is positioned above a top edge of the side walls. The refractor is positioned to allow light from the lighting module to pass through the top aperture and the bottom aperture. The coupling feature forms a ventilation gap between the refractor and the housing.

Another embodiment of the present invention is directed to a refractor for a lighting fixture including an inner surface and an outer surface that form at least one side wall, a top aperture and a bottom aperture. A plurality of coupling features of the refractor includes a portion that is positioned above a top edge of the side walls. The portion is positioned from the side walls so that when the refractor is coupled to the lighting fixture only certain contact points of the refractor are in direct contact with the lighting fixture to form a ventilation gab between the refractor and the lighting fixture.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIGS. 1a and 1b illustrates perspectives views of an example light-emitting diode based lighting fixture, in accordance with an example embodiment of the present disclosure;

FIGS. 2a and 2b illustrates perspectives views of a refractor for a light-emitting diode based lighting fixture, in accordance with an example embodiment of the present disclosure; and

FIG. 3 illustrates a view of an example light-emitting diode based lighting fixture with a venting refractor in accordance with certain example embodiments.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

In the following paragraphs, the present disclosure will be described in further detail by way of examples with reference to the attached drawings. In the description, well known components, methods, and/or processing techniques are omitted or briefly described so as not to obscure the disclosure. As used herein, the “present disclosure” and/or “present invention” refers to any one of the embodiments of the disclosure described herein and any equivalents. Furthermore, reference to various feature(s) of the “present disclosure” is not to suggest that all embodiments must include the referenced feature(s).

The example embodiments discussed herein are directed to high mast luminaires such as the luminaires mounted above roadways. While the example embodiments described herein are in the context of outdoor or high mast luminaires, it should be understood that the embodiments described herein can apply to a variety of luminaires. For example, the embodiments can be used with luminaires located in any environment (e.g., indoor, outdoor, hazardous, non-hazardous, high humidity, etc.). Further, the luminaires described herein can use one or more of a number of different types of light sources, including but not limited to various light-emitting diode (LED) light sources such as discrete LEDs, LED arrays, chip on board LEDs, and organic LED light sources, as well as other types of light sources. Therefore, the example luminaires described herein should not be considered limited to a particular type of light source.

Any luminaires, or components thereof (e.g., housings), described herein can be made from a single piece (e.g., as from a mold, injection mold, die cast, 3-D printing process, extrusion process, stamping process, or other prototype methods). In addition, or in the alternative, a luminaire (or components thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to fixedly, hingedly, removably, slidably, and threadedly.

A coupling feature (including a complementary coupling feature) can allow one or more components and/or portions of an example housing or other component of a light fixture to become coupled, directly or indirectly, to another portion of the example housing or other component of a light fixture. A coupling feature can include, but is not limited to, a snap, Velcro, a clamp, a portion of a hinge, an aperture, a recessed area, a protrusion, a slot, a spring clip, a tab, a detent, and mating threads. One portion of an example housing can be coupled to a light fixture by the direct use of one or more coupling features.

In addition, or in the alternative, a portion of a luminaire can be coupled using one or more independent devices that interact with one or more coupling features disposed on a component of the housing. Examples of such devices can include, but are not limited to, a pin, a hinge, a fastening device (e.g., a bolt, a screw, a rivet), epoxy, glue, adhesive, tape, and a spring. One coupling feature described herein can be the same as, or different than, one or more other coupling features described herein. A complementary coupling feature (also 10 sometimes called a corresponding coupling feature) as described herein can be a coupling feature that mechanically couples, directly or indirectly, with another coupling feature.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

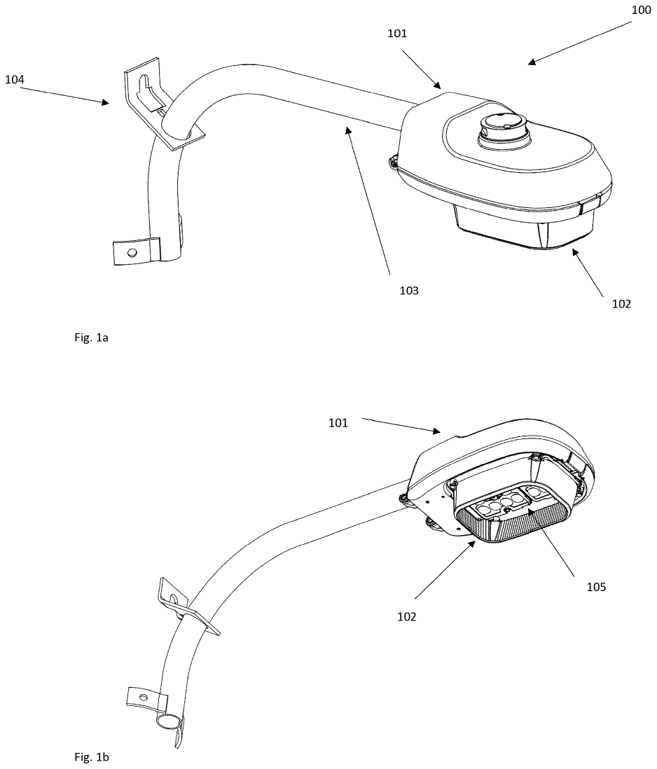

Referring to FIGS. 1a and 1b, perspective bottom and top views of an example luminaire 100 in accordance with one embodiment of the present invention are shown. The example luminaire 100 includes a housing 101 and a refractor 102 coupled to the housing 101. The housing 101 may include various electrical components (not shown) needed for proper operation of the luminaire such as light module drivers, dimming controls, digital wireless control systems and surge protection circuitry. The luminaire 100 may be attached to a pole 103 for mounting, for example, above a roadway. The pole 103 may also include one or more couplers 104 to couple the pole 103 to a structure (not shown).

The luminaire 100 may provide a scalable, variable configurable lighting using one or more lighting modules 105 as shown in FIG. 1b. The lighting modules 105 may be coupled to, or contained in, the housing 101 with a portion of the lighting modules 105 exposed outside the housing 101 to allow light generated by the lighting modules 105 to radiate/exit therefrom. The luminaire 100 may utilize a “mix and match” type system of different sets of the lighting modules 105 to meet a plurality of different lighting requirements. The lighting modules 105 may be varied in light output and features. For example, the lighting modules 105 may be LED light modules which includes a plurality of LED light elements disposed to generate light outwardly from the LED lighting module 105. The LED light elements are powered by one or more drivers (not shown).

A major challenge in devising outdoor LED lighting fixtures is to ensure that the light from the lighting modules 105 is directed effectively and efficiently where it is desired. In particular, for street lighting, a light distribution pattern that extends along the street, and to a lesser extent out into the street, is often desired, with little or no light going back onto street-front properties behind the lamp or upwards. In this regard, reflectors and focusing lenses achieve the desired distribution pattern.

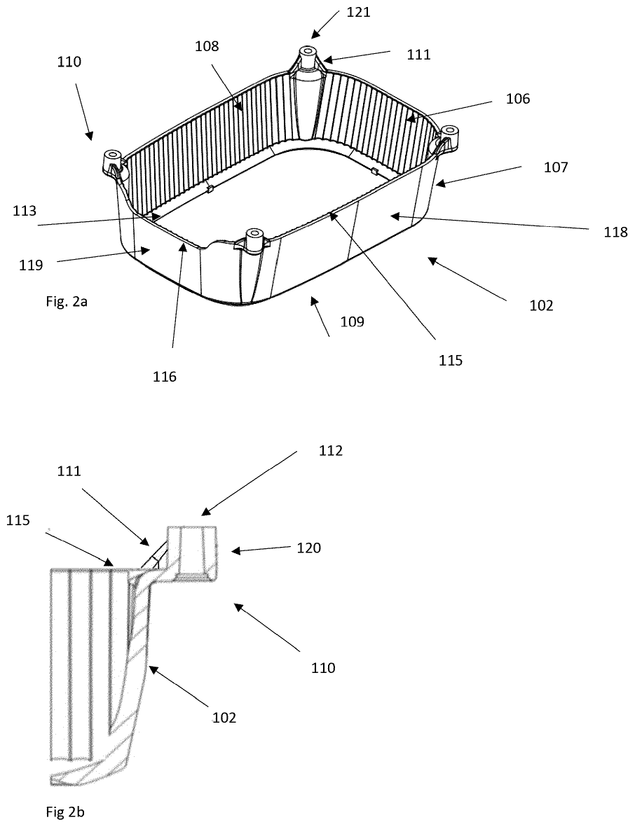

Referring to FIG. 2a, a perspective view of an example refractor 102 in accordance with one embodiment of the present invention is shown. The refractor 102 includes an inner surface 106 and an outer surface 107. The inner and outer surfaces 106, 107 form at least one side wall 118 of the refractor 102 (the refractor 102 may have a circular cross-sectional shape so that only one there is only one side wall 118). The inner surface 106 and the outer surfaces 107 also form a top aperture 108 and a bottom aperture 109. One or both of the inner surface 106 and the outer surface 107 may a plurality of prismatic surfaces or ridges designed the help diffuse the light generated by the lighting modules 105. For example, the prismatic surfaces manipulate the angles and direction through which light waves travel, such that light is both refracted and reflected. The refractor 102 also includes one or more coupling features 110.

As shown in the embodiment of FIG. 2b, the coupling feature 110 may be formed distal from the outer surface 107 and has as least a portion 120 above the top edge 115 of the side wall 118. The coupling feature 110 may include a through hole 121 (shown in FIG. 2a) to allow a screw (not shown) to be used to couple the refractor 102 to the housing 101 or other section of the luminaire 100. In one embodiment, a first O-ring around the head of screw may be used to protect the refractor 102 from over torque and pressure and a second O-ring may be insert on the end of the screw (after the screw is inserted in the hole 121) to keep the screw captive to avoid falling screws when removing the refractor 102. The O-rings may be made from a flexible material such as rubber. As shown in FIGS. 2a and 2b, the refractor 102 may also include a buttress 111 to add strength and support for the coupling feature 110. Of course, it should be understood that other coupling features may be used to couple the refractor 102 to the luminaire 100.

The refractor 102 may be formed from a transparent, refractive, material. For example, in a preferred embodiment of the invention, the refractor 102 is made from a UV stabilized acrylic material. It should be understood that other materials may be used form the refractor 102 such as thermoplastic materials, polycarbonate, and borosilicate glass. The refractor 012 may be formed by injection molding or extrusion or a combination of both techniques and/or other techniques.

As shown in FIG. 2a, the refractor 102 comprises an elongated structure having a generally cross-sectional rectangular shape with rounded corners along its longitudinal axis. It is of course understood that the refractor 102 could have other cross-sectional shapes that include a circular, rectangular, pentagonal, hexagonal, elliptical, octagonal c-shape, hyperbolic, elliptical or other cross-section shape. The refractor 120 should have a structure that generally matches the light exit surface of the lighting modules 105. This will allow the light generated by the lighting modules 105 to pass though the top and bottom apertures 108, 109. The light from the lighting modules 105 may also be refracted and/or diffused by the inner and/or outer walls 106, 107 of the refractor 102. The refractor 102 may also help focus/guide the light from the lighting modules 105 is a desired distribution pattern.

The refractor 102 may be removably or permanently coupled to the luminaire 100. For example, the refractor 102 may be coupled to the housing 101 or directly to the lighting modules 105 via the coupling feature 110.

As noted above, a major concern when designing an LED outdoor fixture is effective heat management. Heat at the semiconductor domain junctions is a primary determinant in the life of the LED and in maintaining a consistent wavelength. LEDs function better and last longer at cold or cool temperatures, and deteriorate more rapidly with increased heat. The design effort to draw heat away from the junctions has often resulted in the LED circuit boards being attached to a finned heat sink, with natural air convection or fans used for cooling. In an outdoor light fixture, however, the ambient temperature may at times be relatively high. When a conventional refractor is attached to the outdoor light fixture, there may be little or no air movement in or around the LED modules of such outdoor light fixture which means that convection heat transfer is limited.

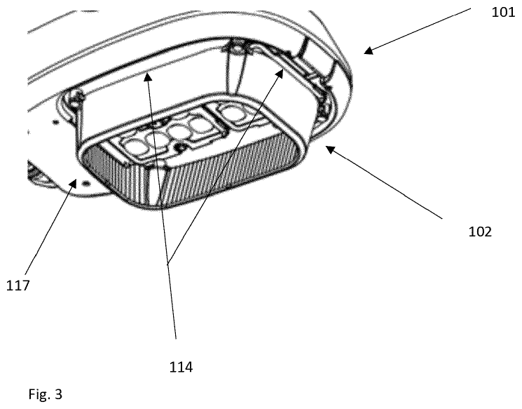

In one embodiment of the present invention, the coupling feature 110 of refractor 102 is used to create one or more ventilation gaps 114 (as shown in FIG. 3) between the housing 101 and the refractor 102 allowing airflow therebetween. As shown in FIG. 2b, the coupling feature 110 may be formed distal from the outer surface 107 and higher than a top edge 115 of the side wall 118 of the refractor 102 formed by the inner surface 106 and the outer surface 107. In this example, the refractor 102 only comes in direct contact with the housing 101 at one or more contact points 112 (shown in FIG. 2b) of the coupling feature 110 creating the ventilation gabs 114 between the refractor 102 and the housing 101 allowing airflow to avoid or reduce the chance of overheating on the luminaire 100. It will be appreciated that more or less contact points may be used to create more or less of the ventilation gaps 114.

In another embodiment, one or more sides of the refractor 102 may also include one or more valleys 113 to allow for greater airflow. A valley side wall 119 has a top edge 115 that is lower than a top edge 116 of the side walls 118 of the reflector 102. The valley 113 creates one or more valley gaps 118 between the housing 101 and the reflector 102. The valley gaps 118 may form an open area that is smaller or larger than the open area formed by one of the ventilation gaps 114. In other embodiments, the refractor 102 may also include cut outs (not shown) in the side walls 118 that can also provide for greater airflow.

When the refractor 102 is coupled to the housing 101, the ventilation gaps 114 and/or the valley gaps 118 allow air to flow in and out of the pocket formed by the coupling of refractor 102 and the housing 101 which improve thermal management. The size, shape, position, and number of the ventilation gaps 114 and the valley gaps 118 should not be considered limiting on the current disclosure.

Table 1 below shows test results using commercially available luminaires (with painted housings and unpainted housings) with various LED configurations and operating wattages. The tests were conducted at an ambient temperature of 40° C. The luminaires with higher wattage produce more light. Driver Temp Max represents the maximum measured temperature that the Driver (the supply of power) should not exceed and LED Temp Max represents the maximum measured temperature that the LED modules should not exceed during normal operation. Measured operating temperatures below those maximums represent a passed test and that the luminaire can operate within rated performance parameters at an ambient temperature of 40° C.

TABLE 1

| | | | | LED |
|---|---|---|---|---|
| | | | Driver | Temp |
| | | | Temp | Max |
| Ambient | Luminaire | | Max | 105° |
| Temp | Setup | Configuration | 90° C. | C. |
| 40° C. | No Paint + | RoadFocus Plus Security-55 W | 83.3 | 99.3 |
| | Refractor | with 10LEDs | | |
| 40° C. | Paint + | RoadFocus Plus Security-55 W | 77.7 | 91.6 |
| | Refractor | with 10LEDs | | |
| 40° C. | Paint + | RoadFocus Plus Security-55 W | 74.5 | 76.8 |
| | Refractor | with 10LEDs | | |
| 40° C. | No Paint + | RoadFocus Plus Security-55 W | 81.5 | 86.6 |
| | Refractor | with 10LEDs | | |
| 40° C. | No Paint + | RoadFocus Plus Security-60 W | 71.7 | 89.1 |
| | Refractor | with 20LEDs | | |
| 40° C. | Paint + | RoadFocus Plus Security-60 W | 63.3 | 64.6 |
| | Refractor | with 20LEDs | | |
| 40° C. | No Paint + | RoadFocus Plus Security-60 W | 69.8 | 89 |
| | Refractor | with 20LEDs | | |
| 40° C. | Paint + | RoadFocus Plus Security-60 W | 64.6 | 82.8 |
| | Refractor | with 20LEDs | | |
| 40° C. | No Paint + | RoadFocus Plus Security-60 W | 72.4 | 93.1 |
| | Refractor | with 20LEDs | | |
| 40° C. | Paint + | RPN-85 W20L4K FOT | 74.2 | 97.8 |
| | Refractor | | | |
| 40° C. | Paint + | RoadFocus Plus Security-95 W | 74.2 | 104.6 |
| | Refractor | with 20LEDs | | |
| 40° C. | Paint | RoadFocus Plus Security-95 W | 73.5 | 102.4 |
| | | with 20LEDs | | |

Other embodiments of the present invention allow the existing luminaires to be retrofit with the refractor 102 without changing or affecting the certifications of the existing luminaire. In this regard, the refractor's 102 can match the cross-sectional shape of any existing refractor and the coupling feature 110 can match any existing coupling feature of the existing luminaire. This greatly simplifies installation of the refractor 102.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components, the terms used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

In the claims references in parentheses refer to reference signs in drawings of exemplifying embodiments or to formulas of embodiments, thus increasing the intelligibility of the claim. These references shall not be construed as limiting the claim.

1. An outdoor lighting fixture, comprising:
a housing;
a lighting module that is coupled to the housing; and
a refractor coupled to the outdoor lighting fixture including an inner surface and an outer surface that from at least one side wall, a top aperture and a bottom aperture, the refractor also includes a coupling feature including a portion extending above a top edge of the at least one side wall,
wherein the refractor is positioned to allow light from the lighting module to pass through the top aperture and the bottom aperture, and
wherein the coupling feature forms a ventilation gap between the refractor and the housing; and
wherein a plurality of the coupling features are provided and are positioned distal from the at least one side wall and the refractor only comes in direct contact with the housing or other components of the lighting fixture at a contact point of the portion of coupling feature extending above the top edge to form a plurality of the ventilation gabs between respective coupling features and between the refractor and the housing allowing airflow to reduce overheating on the luminaire.

2. The outdoor lighting fixture of claim 1, wherein the refractor is made from a transparent, refractive, material.

3. The outdoor lighting fixture of claim 1, wherein the refractor 102 has an elongated structure having a generally cross-sectional rectangular shape with rounded corners along its longitudinal axis.

4. The outdoor lighting fixture of claim 1, wherein the refractor has a cross-sectional shape that is generally circular, rectangular, pentagonal, hexagonal, elliptical, octagonal c-shape, hyperbolic, or elliptical.

5. The outdoor lighting fixture of claim 4, wherein the plurality of the coupling features includes a buttress for support.

6. The outdoor lighting fixture of claim 1, wherein at least one of the inner surface and the outer surface has a plurality of prismatic surfaces or ridges designed the help diffuse light generated by the lighting modules.

7. The outdoor lighting fixture of claim 1, where one side wall of the refractor is a valley side wall that includes a valley having a valley top edge that is lower than the top edge of the side wall of the reflector, wherein the valley forms a valley gap between the housing and the reflector.

8. A refractor for an outdoor lighting fixture, comprising:
an inner surface and an outer surface that from at least one side wall, a top aperture and a bottom aperture; and
a plurality of coupling features including a portion extending above a top edge of the at least one side wall, the portion extends from the at least one side wall is so that when the refractor is coupled to the lighting fixture, only the plurality of contact points of the refractor are in direct contact with the lighting fixture and form a ventilation gab (114) between respective coupling features (110) and between the refractor (102) and the lighting fixture (100).

9. The refractor of claim 8, wherein the refractor is made from a transparent, refractive, material.

10. The refractor of claim 8, wherein the refractor has an elongated structure having a generally cross-sectional rectangular shape with rounded corners along its longitudinal axis.

11. The refractor of claim 8, wherein the refractor 102 has a cross-sectional shape that is generally circular, rectangular, pentagonal, hexagonal, elliptical, octagonal c-shape, hyperbolic, or elliptical.

12. The refractor of claim 8, wherein the plurality of the coupling features includes a buttress for support.

13. The refractor of claim 8, wherein one side wall of the refractor is a valley side wall that includes a valley having a valley top edge that is lower than the top edge(s) of the side wall of the reflector, wherein the refractor is coupled to the lighting fixture, the valley forms a valley gap between the luminaire and the reflector.

14. The refractor of claim 8, wherein at least one of the inner surface and the outer surface has a plurality of prismatic surfaces or ridges designed the help diffuse the light.
